(19) United States
(12) Patent Application Publication
(10) Pub. No.: US 2002/0189764 A1
(43) Pub. Date: Dec. 19, 2002

(54) Butt splicer apparatus

(76) Inventors: John Keene, Durand, IL (US); Christopher J. Plude, Beloit, WI (US)

Correspondence Address: David J. Arlher, 9790 Forest Preserve RD., Durand, IL, 61024, US

(21) Appl. No.: 09/880,336

(22) Filed: Jun. 13, 2001

(51) Int. Cl. B31F 5/00

(52) U.S. Cl. 156/353; 156/510; 156/502

(57) ABSTRACT

A butt splicer apparatus is disclosed for butt splicing a tail end of a roll having a first and second label mounted in series thereon with a leading edge of a new roll having a first and second further label mounted in series thereon. The apparatus includes a cutter for cutting through the tail end and a detector for detecting a location disposed along the tail end so that movement of the location past the detector generates a signal. The apparatus also includes a rotatable drive for driving the tail end relative to the cutter, the signal controlling rotation of the drive. The arrangement is such that the second label and the further second label are registered congruently relative to each other with the cutter disposed between the first and second label. When the cutter cuts through the tail end, the cut tail end and leading edge are butt spliced together with the first label and the second further label aligned relative to each other so that a distance between the first label and the second further label mounted on the spliced rolls is equal to a further distance between other adjacent labels mounted on the spliced rolls so that application of the labels from the spliced rolls is uninterrupted.

### BACKGROUND OF THE INVENTION

The present invention relates to a butt splicer apparatus. More specifically, the present invention relates to an apparatus for butt splicing a tail end of a roll having a first and second label mounted in series thereon with a leading edge of a new roll having a first and second further label mounted in series thereon.

The application of individual labels to containers such as bottles or cans and the like involves the use of a label application machine. Such a label application machine typically includes a roll of backing liner having equally spaced labels attached or mounted thereon in series. When the backing liner is brought into close proximity to the container to be labelled, the direction of movement of the backing liner is changed so that the label on the liner separates from the backing liner carrier. The separated label includes an adhesive coating which adheres to the container so that the container is wrapped by the adhesive label.

However, the aforementioned roll of backing liner with attached labels has a finite length. Accordingly, when the roll of labels has been depleted, it becomes necessary to stop the labelling process while a new roll of labels is fitted to the labelling machine. Needless to say, modem production plants will ideally include a continuous production line with a minimum number of stops for maintenance. Although a roll of labels may last for 1-2 hours, it has been customary for the production line to be stopped while a new roll of labels is threaded into the labelling machine.

Although it is known to splice the new roll of labels to the tail end of the depleted roll, such splice has meant that some labels overlap thus causing incorrect application of some of the labels.

The present invention overcomes the aforementioned problem of stopping a production line to replenish a roll of labels. More specifically, the present invention provides a butt splicer apparatus in which the new roll of labels is butt spliced to the tail end of the used roll and in which each label on the spliced rolls is equally spaced from an adjacent label.

The arrangement according to the present invention enables the space between adjacent labels on opposite sides of the splice to be the same as the space between all the other adjacent labels of the spliced rolls. The present invention also applies splicing tape to the backing liner on the side opposite the labels so as not to interfere with removal and application of the labels. Therefore, the present invention enables application of all the labels on the used roll up to the splice and then all the labels on the new roll upstream from the splice. Accordingly, the application of the labels remains uninterrupted such that the production line can remain up and running.

Therefore, it is a primary feature of the present invention to provide a butt splicer apparatus that overcomes the problems associated with prior art arrangements.

Another feature of the present invention is the provision of a butt splicer apparatus that enables application of labels without interruption.

A further feature of the present invention is the provision of a butt splicer apparatus of relatively low cost.

Another feature of the present invention is the provision of a butt splicer apparatus that enables splicing of a leading edge of a new roll of labels to the tail end of a running roll of labels without stopping an application of the labels.

Other features and advantages of the present invention will be readily apparent to those skilled in the art by a consideration of the detailed description of a preferred embodiment of the present invention contained herein.

### BRIEF SUMMARY OF THE INVENTION

The present invention relates to a butt splicer apparatus for butt splicing a tail end of a roll having a first and second label mounted in series thereon with a leading edge of a new roll having a first and second further label mounted in series thereon. The apparatus includes a cutter for cutting through the tail end and a detector for detecting a location disposed along the tail end so that movement of the location past the detector generates a signal. The apparatus also includes a rotatable drive for driving the tail end relative to the cutter, the signal controlling rotation of the drive. The arrangement is such that the second label and the further second label are registered congruently relative to each other with the cutter disposed between the first and second label. When the cutter cuts through the tail end, the cut tail end and leading edge are butt spliced together with the first label and the second further label aligned relative to each other so that a distance between the first label and the second further label mounted on the spliced rolls is equal to a further distance between other adjacent labels mounted on the spliced rolls so that application of the labels from the spliced rolls is uninterrupted.

In a more specific embodiment of the present invention, the butt splicer apparatus further includes a tape for butt splicing together the cut tail end and the leading edge so that the distance between the first label and the second further label mounted on the spliced rolls is equal to the further distance between other adjacent labels mounted on the spliced rolls so that application of the labels from the spliced rolls is uninterrupted.

The tape includes a backing having a first and a second face and a layer of self adhesive covering the first face of the backing. The tape is applied to the cut tail end and leading edge so that the layer of self adhesive is disposed between the backing and the abutting tail end and leading edge. The tape is applied on an opposite side of the tail end and leading edge relative to the labels.

Moreover, the cutter also cuts through the leading edge between the first and second further label for generating a cut defined by the leading edge and the cutter cuts through the tail end between the first and second label for generating a further cut defined by the tail end.

Furthermore, the cut and the further cut are generated simultaneously.

The cutter includes a blade for cutting the tail end and the leading edge and a carriage for supporting the blade. A rail is provided for guiding the carriage, the rail being disposed normal to a direction of movement of the tail end. The arrangement is structured and arranged such that when the tail end and leading edge are accurately registered relative to each other, the blade supported by the carriage is moved transversely across the tail end and leading edge guided by the rail for cutting the tail end and leading edge.

Additionally, the leading edge is disposed between the blade and the tail end.

In another embodiment of the present invention, the cutter includes a blade and a slide for guiding the blade for guillotining the leading edge and the tail end.

In yet another embodiment of the present invention, the cutter is a laser cutter.

Also, in a preferred embodiment of the present invention, the location is associated with a change in opacity between the first label mounted on the tail end of the roll and the tail end disposed between adjacent labels.

More specifically, the detector detects the change in opacity, the detector generating the signal which is commensurate with the change in opacity.

The detector includes an emitter for emitting a beam which is directed towards the tail end of the roll and a light sensitive target is disposed on an opposite side of the tail end relative to the emitter for receiving the beam. A generator is provided for generating the signal commensurate with the change in opacity, the change in opacity being proportional to the intensity of the beam received by the target.

In another embodiment of the present invention, the detector includes an emitter for emitting a beam which is directed towards the tail end of the roll. A light sensitive target is disposed on a same side of the tail end relative to the emitter for receiving a reflected beam and a generator is provided for generating a signal which is commensurate with the reflectivity.

In another embodiment of the present invention, the location is a mark disposed on the tail end.

More specifically, the mark is preprinted on the tail end at a predetermined distance from an edge of the first label and the detector detects the mark and generates a signal so that determination of the location relative to the cutter is permitted so that the cutter cuts the tail end between the first and second labels.

The detector, in one embodiment of the present invention, detects the location by reflectivity. However, in another embodiment of the present invention, the detector detects the location by detecting a change in color.

In yet another embodiment of the present invention, the detector detects the location by detecting a change in capacitance.

The drive includes an electric motor, the motor being selectively connected to a source of electrical power. A transmission is driven by the motor, the transmission extending between the motor and a driven roller for controllably driving the tail end of the roll for accurately positioning the first and second labels of the roll relative to the cutter.

Many modifications and variations of the present invention will be readily apparent to those skilled in the art by a consideration of the detailed description contained hereinafter taken in conjunction with the annexed drawings which show a preferred embodiment of the present invention. However, such modifications and variations fall within the spirit and scope of the present invention as defined by the appended claims.

### BRIEF DESCRIPTION OF THE DRAWINGS

FIG. 1 is a perspective view of a butt splicer apparatus illustrating the inventive concept of the present invention;

FIG. 2 is a similar view to that shown in FIG. 1 but shows a second label disposed congruently with a second further label of a new roll;

FIG. 3 is a similar view to that shown in FIG. 1 but shows the cutter cutting the tail end;

FIG. 4 is a similar view to that shown in FIG. 1 but shows application of a splicing tape;

FIG. 5 is a sectional view taken on the line 5-5 of FIG. 4;

FIG. 6 is an enlarged side elevational view of the detector;

FIG. 7 is a similar view to that shown in FIG. 6 but shows another embodiment of the present invention;

FIG. 8 is a side elevational view of a commercial apparatus according to the present invention;

FIG. 9 is a similar view to that shown in FIG. 1 but shows an alternative embodiment of the present invention;

FIG. 10 is a view similar to that shown in FIG. 1 but shows another embodiment of the present invention; and

FIG. 11 is a view similar to that shown in FIG. 1 but shows yet another embodiment of the present invention.

Similar reference characters refer to similar parts throughout the various views of the drawings.

### DETAILED DESCRIPTION

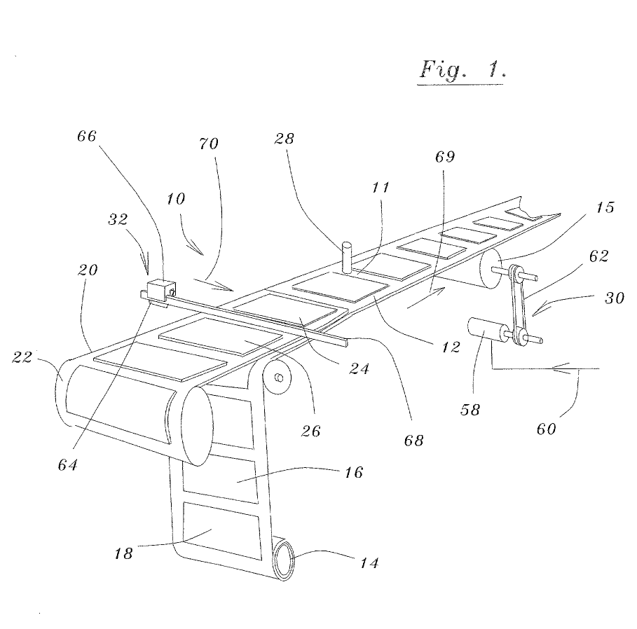

FIG. 1 is a perspective view of a butt splicer apparatus illustrating the inventive concept of the present invention. More specifically, FIG. 1 shows for illustration purposes only the concept of the present invention and how according to the present invention rolls of labels are butt spliced together. As shown in FIG. 1, a butt splicer apparatus generally designated 10 is used for butt splicing a tail end 12 of a roll 14 having a first and second label 16 and 18 respectively mounted in series thereon with a leading edge 20 of a new roll 22 having a first and second further label 24 and 26 respectively mounted in series thereon. The apparatus 10 includes a cutter generally designated 32 for cuffing through the tail end 12 and a detector 28 for detecting a location 11 disposed along the tail end 12 so that movement of the location 11 past the detector 28 generates a signal. The apparatus 10 also includes a rotatable drive generally designated 30 for driving the tail end 12 relative to the cutter 32, the signal controlling rotation of the drive 30.

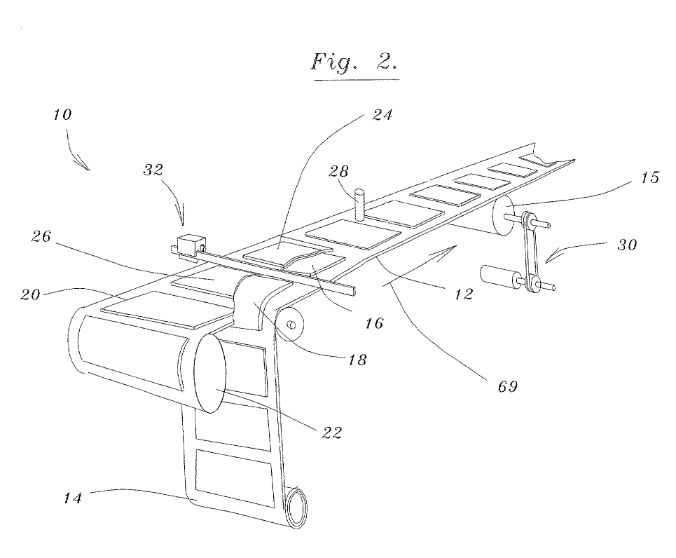

FIG. 2 is a similar view to that shown in FIG. 1 but shows the drive 30 having moved the tail end 12 in the direction indicated by the arrow 69. As shown in FIG. 2, the arrangement is such that the second label 18 and the further second label 26 are registered congruently relative to each other with the cutter 32 disposed between the first and second label 16 and 18.

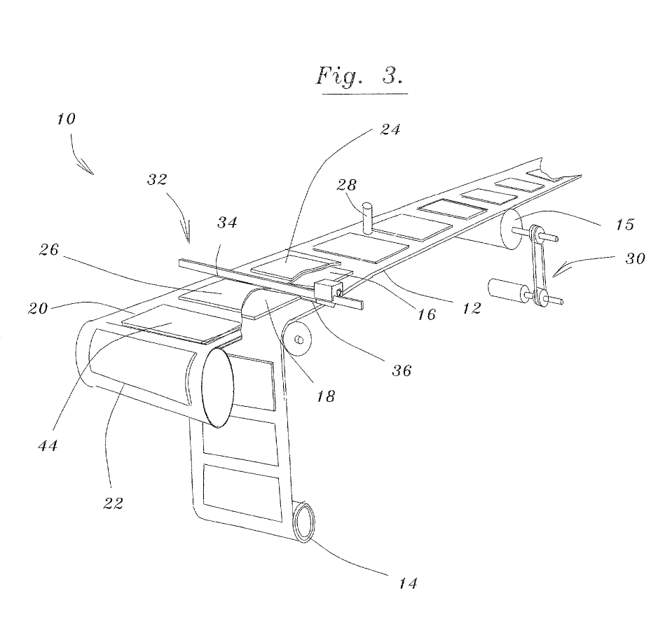

FIG. 3 is a similar view to that shown in FIG. 2 but shows the cut tail end 12 and leading edge 20.

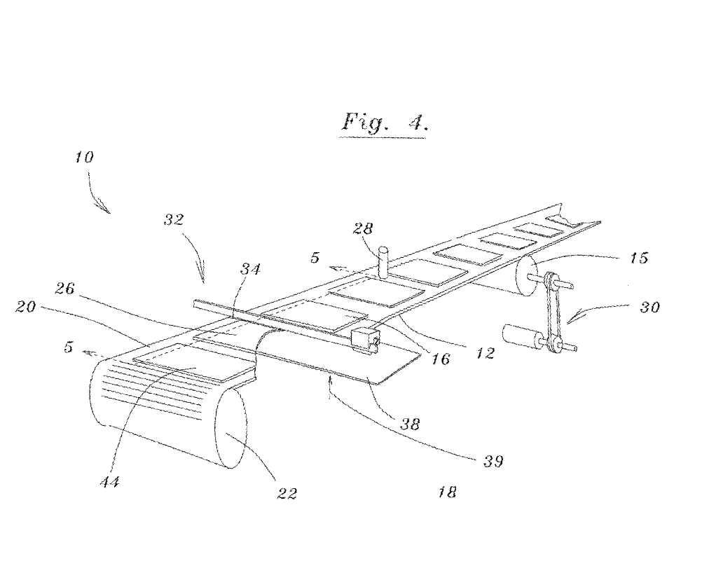

FIG. 4 is a similar view to that shown in FIG. 3 but shows the cut tail end 12 and leading edge 20 being butt spliced. As shown in FIG. 4, when the cutter 32 cuts through the tail end 12, the cut tail end 12 and leading edge 20 are butt spliced together with the first label 16 and the second further label 26 aligned relative to each other.

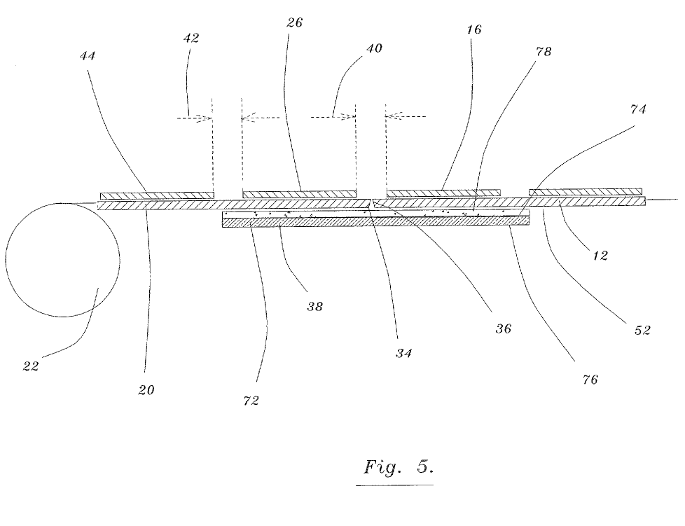

FIG. 5 is a sectional view taken on the line 5-5 of FIG. 4. As shown in FIG. 5, the cut tail end 12 and leading edge 20 are butt spliced together so that a distance 40 between the first label 16 and the second further label 26 mounted on the spliced rolls 14 and 22 is equal to a further distance 42 between other adjacent labels such as labels 26 and 44 mounted on the spliced rolls 14 and 22 so that application of the labels 16, 26 and 44 from the spliced rolls 14 and 22 is uninterrupted.

As shown in FIG. 5, the tape 38 includes a backing 72 having a first and a second face 74, 76 and a layer of self adhesive 78 covering the first face 74 of the backing 72. The tape 38 is applied to the cut 34 and further cut 36 so that the layer of self adhesive 78 is disposed between the backing 72 and the abutting tail end 12 and leading edge 20. The tape 38 is applied on an opposite side 52 of the tail end 12 and leading edge 20 relative to the labels 16, 26.

As shown in FIG. 3, the cutter 32 also cuts through the leading edge 20 between the first and second further labels 24 and 26 for generating a cut 34 defined by the leading edge 20 and the cutter 32 cuts through the tail end 12 between the first and second label 16 and 18 for generating a further cut 36 defined by the tail end 12. Furthermore, the cut and the further cut 34 and 36 are generated simultaneously.

As shown in FIG. 1, the cutter 32 includes a blade 64 for cutting the tail end 12 and the leading edge 20 and a carriage 66 for supporting the blade 64. A rail 68 is provided for guiding the carriage 66, the rail 68 being disposed normal to a direction of movement of the tail end 12 as indicated by the arrow 70. The arrangement is structured and arranged such that when the tail end 12 and leading edge 20 are accurately registered relative to each other, the blade 64 supported by the carriage 66 is moved transversely across the tail end 12 and leading edge 20 guided by the rail 68 for cutting the tail end and leading edge 12 and 20.

Additionally, as shown in FIG. 1, the leading edge 20 is disposed between the blade 64 and the tail end 12.

Also, in a preferred embodiment of the present invention, as shown in FIG. 1, the location 11 is associated with a change in opacity between a label supported by the liner and the liner between adjacent labels. More specifically, the detector 28 detects the change in opacity, the detector 28 generating the signal which is commensurate with such change in opacity.

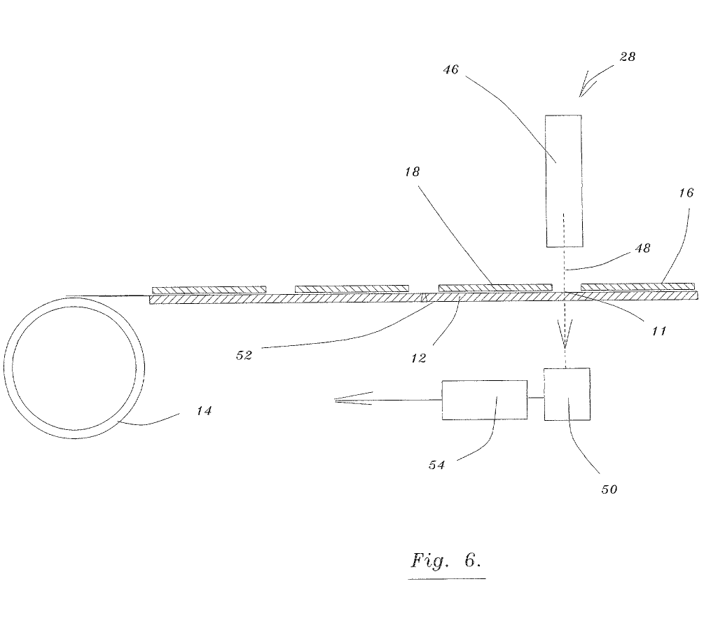

FIG. 6 is an enlarged side elevational view of the detector. As shown in FIG. 6, the detector 28 includes an emitter 46 for emitting a beam 48 which is directed towards the tail end 12 of the roll 14 and a light sensitive target 50 is disposed on an opposite side 52 of the tail end 12 relative to the emitter 46 for receiving the beam 48. A generator 54 is provided for generating the signal commensurate with the change in opacity, the change in opacity being proportional to the intensity of the beam 48 received by the target 50.

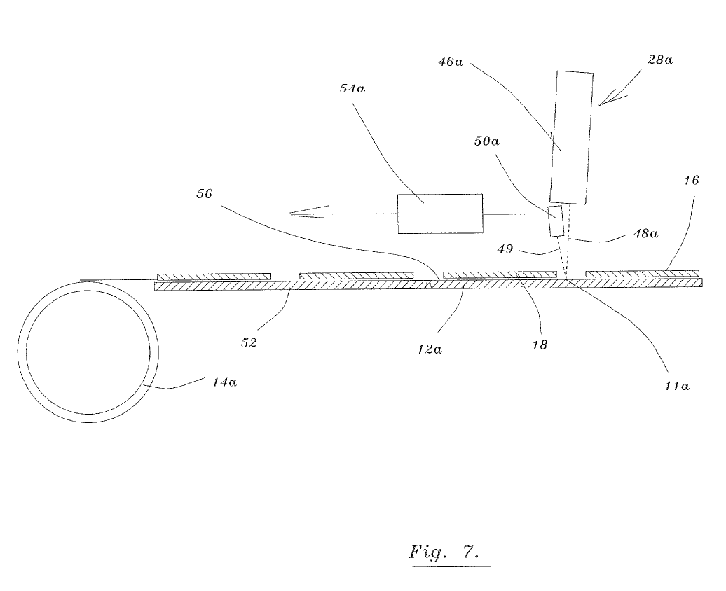

FIG. 7 is a similar view to that shown in FIG. 6 but shows another embodiment of the present invention. As shown in FIG. 7, a detector 28a includes an emitter 46a for emitting a beam 48a which is directed towards the tail end 12a of the roll 14a. A light sensitive target 50a is disposed on a same side 56 of the tail end 12a relative to the emitter 46a for receiving a reflected beam 49 and a generator 54a is provided for generating a signal commensurate with the change in intensity of the reflected beam 49 relative to the beam 48a.

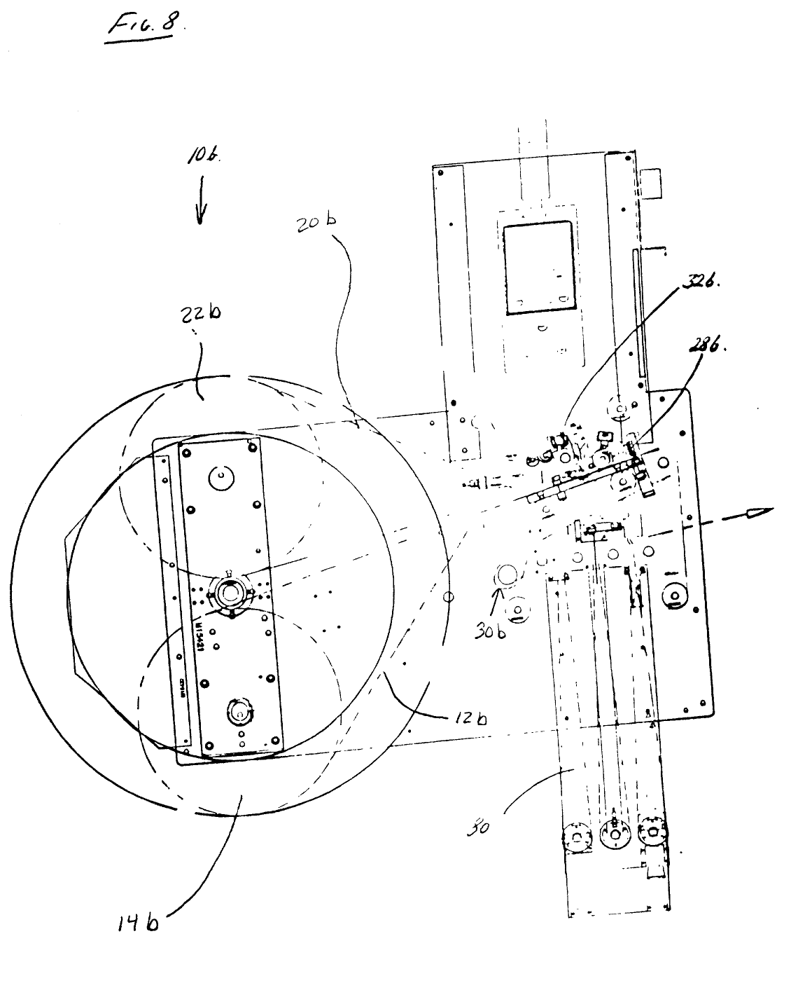

In the embodiments described herein, the concept of the present invention is shown in simplified form for the purposes of clarity. However, FIG. 8 is a side elevational view of a commercial apparatus according to the present invention. As shown in FIG. 8, the apparatus 10b includes means for conveying the backing liner or carrier liner with labels thereon through a festoon 80 or equivalent mechanism so that the tail end 12b of the roll 14b can be positioned and worked on for a period of time without interrupting movement of the carrier liner and labels to the labelling location. Accordingly, a detector 28b is located upstream from the festoon 80 and the signal generated by the detector is correlated to the drive 30b for moving the tail end 12b relative to the stationary leading edge 20b of the new roll 22b. The signal taken in conjunction with the diameter of the roll 14b can be correlated so that an accurate determination can be made of the relative positions of the adjacent labels 16b and 26b (not shown) so that the splice can be made without interrupting the flow of equally spaced labels.

Although reference is made to a web storage festoon 80, it will be understood by those skilled in the art that other mechanisms could be employed in place of a festoon 80. For example, a loop of a roll could be accumulated within a holding box so that when the splice has been completed, the labels mounted on the carrier liner of the roll can be fed to the label applicator machine (not shown) and the splice and new roll can follow through the holding box and onto the labelling machine. Alternatively, instead of a festoon 80 a free loop of the labels supported by the liner could be provided.

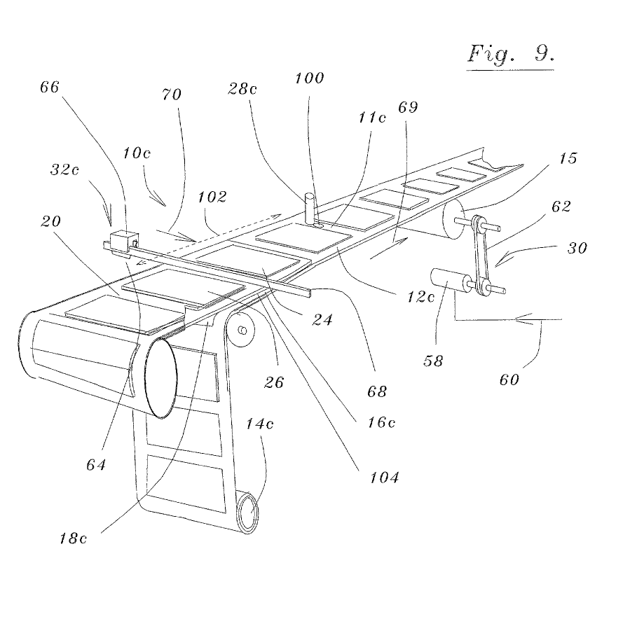

FIG. 9 is a similar view to that shown in FIG. 1 but shows an alternative embodiment of the present invention. As shown in FIG. 9, the location is a mark 100 disposed on the tail end 12c.

More specifically, the mark 100 is preprinted on the tail end 12c at a predetermined distance 102 from an edge 104 of the first label 16c. The detector 28c detects the mark 100 and generates a signal so that determination of the location 11c relative to the cutter 32c is permitted so that the cutter 32c cuts the tail end 12c between the first and second labels 16c and 18c.

As shown in FIG. 7, the detector 28a, detects the location 11 a by reflectivity and the target 50a measures the difference in the intensity of the beam 48a compared with the intensity of beam 49.

However, in another embodiment, a detector detects the location by detecting a change in color.

In yet another embodiment a detector detects the location by detecting a change in capacitance.

As shown in FIGS. 1-4, the drive 30 includes an electric motor 58, the motor 58 being selectively connected to a source of electrical power 60. A transmission 62 is driven by the motor 58. The transmission 62 extends between the motor 58 and a driven roller 15 for controllably driving the tail end 12 of the roll 14 for accurately positioning the tail end 12 of the roll 14 relative to the cutter 32.

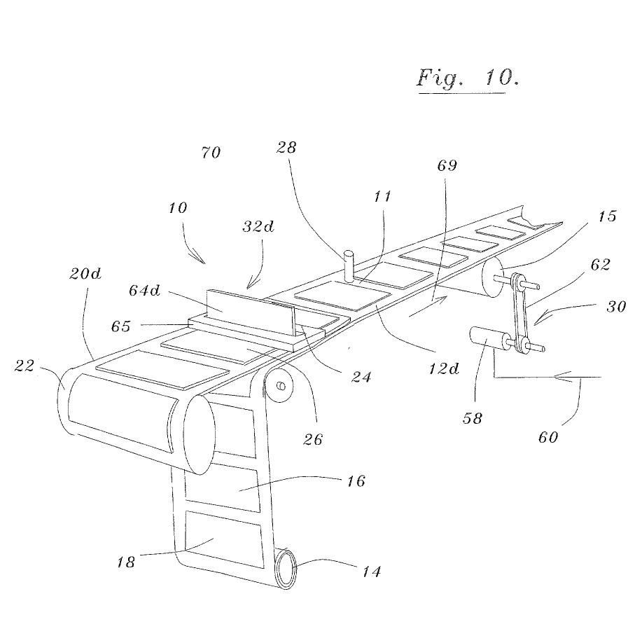

FIG. 10 is a view similar to that shown in FIG. 1 but shows another embodiment of the present invention. As shown in FIG. 10, the cutter 32d includes a blade 64d and a slide 65 for guiding the blade 64d for guillotining the leading edge 20d and the tail end 12d.

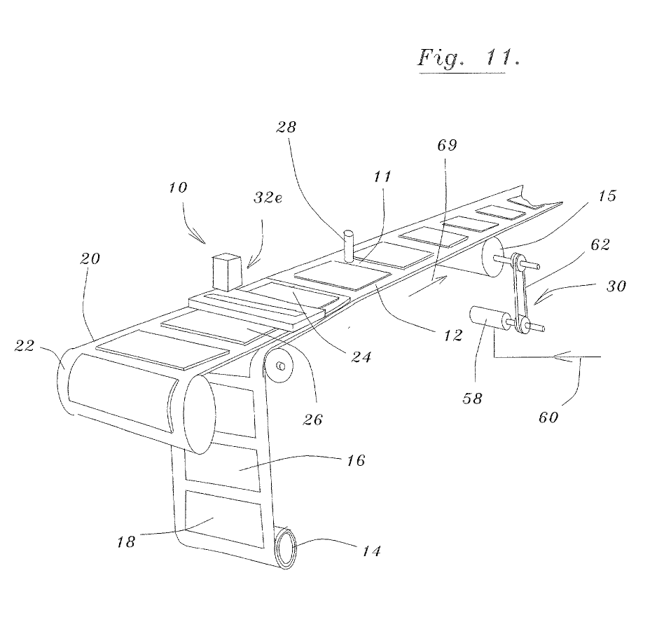

FIG. 11 is a view similar to that shown in FIG. 1 but shows yet another embodiment of the present invention. As shown in FIG. 11, the cutter 32e is a laser cutter.

In operation of the apparatus according to the present invention, the first and second label 16 and 18 of the tail end 12 are accurately aligned on opposite sides of the cutter 32 as a result of the signal generated by the detector 28. Once the tail end 12 has been accurately aligned with the cutter 32, the cutter 32 cuts through the space between adjacent labels 16 and 26 and the tape 38 is applied to the cut in order to splice the cut tail end 12 and leading edge 20 together. When the rolls have been spliced together, the labels on both rolls will be equally aligned and the space 40 between the last label 16 on the roll 14 before the splice and the first label 26 on the new roll 22 immediately after the splice will be the same as the space such as space 42 between any of the other adjacent labels on the roll or new roll so that application of the labels can remain uninterrupted.

It will be appreciated by those skilled in the art that the arrangement shown in FIG. 9 is particularly applicable to rolls of labels in which adjacent labels abut against each other. The arrangement in which a change in opacity is used to generate a signal finds particular application where the labels are spaced relative to each other along the liner. Also, although the apparatus can be used to cut through both the leading edge and the tail end, the leading edge could be prepared before the splicing operation with a splice tape applied to a cut leading edge prior to location of the labels 16 and 18 so that when the label 18 is located congruently with the further label 26 and the tail end is cut between labels 16 and 18, the splicing tape attached to the liner opposite to the label 26 is also applied to the liner of the tail end 12 opposite to the label 16.

Furthermore, it will be understood that although for illustration purposes, the labels are shown uppermost on the liners, the labels could be mounted beneath the liners and the tape applied automatically from above in order to accomplish a splice as shown in FIG. 8.

The present invention provides a unique apparatus for butt splicing together two rolls of labels so that the application of such labels is uninterrupted during such splicing.

What is claimed is:

1. A butt splicer apparatus for butt splicing a tail end of a roll having a first and second label mounted in series thereon with a leading edge of a new roll having a first and second further label mounted in series thereon, said apparatus comprising:
a cutter for cutting through the tail end;
a detector for detecting a location disposed along the tail end so that movement of said location past said detector generates a signal; and
a rotatable drive for driving the tail end relative to said cutter, said signal controlling rotation of said drive so that the second label and the further second label are registered congruently relative to each other with the cutter being disposed between the first and second label, the arrangement being such that when said cutter cuts through the tail end, the cut tail end and leading edge are butt spliced together with the first label and the second further label aligned relative to each other so that a distance between the first label and the second further label mounted on the spliced rolls is equal to a further distance between other adjacent labels mounted on the spliced rolls so that application of the labels from the spliced rolls is uninterrupted.

2. A butt splicer apparatus as set forth in claim 1 further including:
a tape for butt splicing together the cut tail end and the leading edge so that said distance between the first label and the second further label mounted on the spliced rolls is equal to the further distance between other adjacent labels mounted on the spliced rolls so that application of the labels from the spliced rolls is uninterrupted.

3. A butt splicer apparatus as set forth in claim 2 wherein
said tape includes:
a backing having a first and a second face;
a layer of self adhesive covering said first face of said backing, said tape being applied to the cut tail end and the leading edge so that said layer of self adhesive is disposed between said backing and said abutting tail end and leading edge, said tape being applied on an opposite side of the tail end and leading edge relative to the labels.

4. A butt splicer apparatus as set forth in claim 1 wherein
said cutter also cuts through the leading edge between the first and second further label for generating a cut defined by the leading edge and the cutter cuts through the tail end between the first and second label for generating a further cut defined by the tail end.

5. A butt splicer apparatus as set forth in claim 4 wherein
said cut and said further cut are generated simultaneously.

6. A butt splicer apparatus as set forth in claim 1 wherein
said cutter includes:
a blade for cutting the tail end and the leading edge;
a carriage for supporting said blade;
a rail for guiding said carriage, said rail being disposed normal to a direction of movement of the tail end, the arrangement being structured and arranged such that when the tail end and leading edge are accurately registered relative to each other, said blade supported by said carriage is moved transversely across the tail end and leading edge guided by said rail for cutting the tail end and leading edge.

7. A butt splicer apparatus as set forth in claim 6 wherein
the leading edge is disposed between said blade and the tail end.

8. A butt splicer apparatus as set forth in claim 1 wherein
said cutter includes:
a blade;
a slide for guiding said blade for guillotining the leading edge and the tail end.

9. A butt splicer apparatus as set forth in claim 1 wherein
said cutter is a laser cutter.

10. A butt splicer apparatus as set forth in claim 1 wherein
said location is associated with a change in opacity between the first label mounted on the tail end of the roll and the tail end disposed between adjacent labels.

11. A butt splicer apparatus as set forth in claim 10 wherein
said detector detects said change in opacity, said detector generating said signal which is commensurate with said change in opacity.

12. A butt splicer apparatus as set forth in claim 11 wherein
said detector includes:
an emitter for emitting a beam which is directed towards the tail end of the roll;
a light sensitive target disposed on an opposite side of the tail end relative to said emitter for receiving said beam;
a generator for generating said signal commensurate with said change in opacity, said change in opacity being proportional to the intensity of said beam received by said target.

13. A butt splicer apparatus as set forth in claim 1 wherein
said detector includes:
an emitter for emitting a beam which is directed towards the tail end of the roll;
a light sensitive target disposed on a same side of the tail end relative to said emitter for receiving a reflected beam;
a generator for generating said signal commensurate with a change in intensity of said beam compared with said reflected beam received by said target.

14. A butt splicer apparatus as set forth in claim 1 wherein
said location is a mark disposed on the tail end.

15. A butt splicer apparatus as set forth in claim 14 wherein
said mark is preprinted on the tail end at a predetermined distance from an edge of the first label.

16. A butt splicer apparatus as set forth in claim 14 wherein
said detector detects said mark and generates said signal so that determination of said location relative to said cutter is permitted so that said cutter cuts the tail end between the first and second labels.

17. A butt splicer apparatus as set forth in claim 1 wherein
said detector detects said location by reflectivity.

18. A butt splicer apparatus as set forth in claim 1 wherein
said detector detects said location by detecting a change in color.

19. A butt splicer apparatus as set forth in claim 1 wherein
said detector detects said location by detecting a change in capacitance.

20. A butt splicer apparatus as set forth in claim 1 wherein
said drive includes:
an electric motor, said motor being selectively connected to a source of electrical power;
a transmission driven by said motor;
a driven roller, said transmission extending between said motor and said driven roller for controllably driving the tail end of the roll for accurately positioning the tail end of the roll relative to said cutter.

21. A butt splicer apparatus for butt splicing a tail end of a roll having a first and second label mounted in series thereon with a leading edge of a new roll having a first and second further label mounted in series thereon, said apparatus comprising:
a cutter for cutting through the tail end;
a detector for detecting a location disposed along the tail end so that movement of said location past said detector generates a signal;
a rotatable drive for driving the tail end relative to said cutter, said signal controlling rotation of said drive so that the second label and the further second label are registered congruently relative to each other with the cutter being disposed between the first and second label, the arrangement being such that when said cutter cuts through the tail end, the cut tail end and leading edge are butt spliced together with the first label and the second further label aligned relative to each other so that a distance between the first label and the second further label mounted on the spliced rolls is equal to a further distance between other adjacent labels mounted on the spliced rolls so that application of the labels from the spliced rolls is uninterrupted; and
a tape for butt splicing together the cut tail end and the leading edge.

22. A butt splicer apparatus for butt splicing a tail end of a roll having a first and second label mounted in series thereon with a leading edge of a new roll having a first and second further label mounted in series thereon, said apparatus comprising:
a cutter for cutting through the leading edge and the tail end;
a detector for detecting a location disposed along the tail end so that movement of said location past said detector generates a signal;
a rotatable drive for driving the tail end relative to said cutter, said signal controlling rotation of said drive so that the second label and the further second label are registered congruently relative to each other with the cutter being disposed between the first and second label, the arrangement being such that when said cutter cuts through the leading edge and the tail end, the cut tail end and leading edge are butt spliced together with the first label and the second further label aligned relative to each other so that a distance between the first label and the second further label mounted on the spliced rolls is equal to a further distance between other adjacent labels mounted on the spliced rolls so that application of the labels from the spliced rolls is uninterrupted; and
a tape for butt splicing together the cut tail end and the leading edge.
